(19) United States
(12) Patent Application Publication
(10) Pub. No.: US 2005/0019943 A1
(43) Pub. Date: Jan. 27, 2005

(54) Automatic blood analysis and identification system

(76) Inventors: Sam M. Chaoui, Diamond Bar, CA (US); Walter W. Mosher JR., West Hills, CA (US); Mark M. Kotik, Santa Monica, CA (US)

Correspondence Address: KELLY BAUERSFELD LOWRY & KELLEY, LLP, 6320 CANOGA AVENUE, SUITE 1650, WOODLAND HILLS, CA, 91367, US

(21) Appl. No.: 10/616,892

(22) Filed: Jul. 9, 2003

(51) Int. Cl. G01N 21/03

(52) U.S. Cl. 436/165

(57) ABSTRACT

An automatic blood analysis and identification system permits patient identification and other vital information, such as blood type and Rh factor, to be automatically printed directly on a container holding a bodily fluid sample almost immediately after the sample has been drawn and analyzed. There is no manual handling of the sample between the draw and the identification. The system includes a carrier unit for holding at least one clear sample container, and a printer disposed within the unit for printing information onto the sample container. A photo-analyzer analyzes a bodily fluid sample within the sample container, and sends information to the printer which prints the information onto the sample container. The system may also be configured to utilize radio frequency identification (RFID) technology to imprint electronic data bearing the information onto a microchip implanted within the sample container.

### BACKGROUND OF THE INVENTION

The present invention generally relates to blood analysis techniques. More particularly, the present invention relates to an automatic blood analysis and identification system.

There is a great need for accurate, efficient analysis and identification of samples of bodily fluids. A particularly important need for such analysis occurs in hospital and medical settings. Blood samples may be drawn for many reasons, including the testing of donated blood for blood type, Rh factor, HIV infection, etc. Prior to analysis, blood samples are drawn from a patient and placed in a container, such as a test tube. A label may be placed on the tube by hand and identifying information relating to the source of the sample may be handwritten on the label. The identification information may include a patient's name, patient number, etc.

While this has been useful to identify samples, some hospitals and medical clinics have experienced problems correlating samples with the results of tests on those samples, etc. due to mislabeling and clerical errors in the handling of such routine matters. These errors can result in the dispensing of the wrong blood to a patient undergoing a procedure, either because the patient's blood type was misidentified and/or the blood type/Rh factor of donor blood was misidentified.

The current (manual) blood draw process involves a great deal of human interaction and, consequently, creates the possibility of human error. Based on doctor's orders, a nurse selects the necessary vacuum blood containers to withdraw blood from a patient. The varieties of vacuum blood containers is based on a number of factors, including blood draw volume, reagents within the container necessary for tests specified by the physician, and the size of vacuum container required.

A fresh tube is selected that has needles on both ends—one to be inserted in the patient's arm and the other needle to pierce the rubber stopper of the vacuum container. The tube also has a manual clamp in order to stanch the blood flow. The nurse also picks up a fresh vacuum container holder, which facilitates the swapping of vacuum containers when drawing multiple samples. One of the needles at the end of the blood draw tube is inserted into the holder and is held in place by an automatic snap. The other needle at the opposite end of the tube is inserted into the patients arm and the clamp is closed to prevent blood flow. The first vacuum container can now be inserted into the holder. It is held in place by automatic snap. During -the insertion, the needle previously inserted into the holder automatically pierces the rubber stopper.

The nurse releases the clamp in order to allow blood to be drawn into the vacuum container. When the blood stops flowing into the vacuum container, the nurse closes the clamp in order to prevent further blood flow. The filled vacuum container can now be pulled out of the holder. If prescribed by the reagent within the vacuum container, the nurse immediately mixes the blood and reagent by flipping the container upside down the prescribed number of times. The next vacuum container can now be inserted into the holder for an additional blood sample. The process repeats until all prescribed vacuum containers are filled. The nurse then identifies the blood samples according to the hospital's procedure(s).

Many different types of apparatus have been employed to analyze bodily fluids such as blood cells. Blood analysis devices are commonly used in hospital settings to identify the characteristics of a blood sample, such as blood type, Rh factor, platelet count, glucose levels, etc. When a number of characteristics of each blood cell are to be analyzed, blood analyzers are often employed. However, blood analysis systems may also be large, bulky and require that bodily fluids be placed on a slide prior to analysis. For example, U.S. Pat. No. 5,209,903 discloses a large-scale blood analysis system that includes multiple racks with each rack holding multiple samples of bodily fluids. However, before samples can be analyzed, the samples must be taken from sample containers and smeared onto slides. This system is not practical for situations that require immediate results and, due to its relatively large size, would not be able to fit into a small medical office or emergency room.

While methods such as those described above may provide means of analyzing samples of bodily fluids, such methods can always be improved to provide better correlation of samples with results by reducing the handling of the samples prior to, during, and after analysis.

Accordingly, there is a need for a blood analysis system that reduces human error factors related to mislabeling/misidentification of blood samples. What is also needed is blood analysis system that reduces human error factors related to mislabeling/misidentification of donors. There is a further need for a blood analysis system that is automatic. There is an additional need for a blood analysis system that is relatively compact in size and inexpensive. The present invention satisfies these needs and provides other related advantages.

### SUMMARY OF THE INVENTION

A process and system for analyzing a bodily fluid is illustrated and described that reduces human error factors related to the mislabeling or misidentification of blood type. This system is usable in any situation where blood samples are analyzed and labeled for type, including situations where donor blood samples are analyzed and labeled for type, Rh factor, and donor identification. These situations can occur anywhere there is a need to analyze blood, such as hospitals, blood banks, blood-donation organizations, research labs, crime labs, or the like.

An automatic blood analysis and identification system includes a carrier unit that has a means for holding at least one container within the unit (allowing for analysis of single or multiple samples) and a printer disposed within the unit. The printer is capable of printing information onto the at least one container.

The carrier unit includes a photo (light) blood analysis sub-system, such as a photo-analyzer, for analyzing a blood sample within the at least one container in order to determine certain characteristics of the blood sample, such as Blood Type and/or Rh factor. The carrier unit further includes at least one slot within the unit, such that at least one slot holds a sample container. The printer includes a printer head for all the slots or, alternatively, at least one printer head assigned to each slot.

The at least one container may be transparent and may further include a radio frequency identification (RFID) inlet or receiver (i.e., chip & antenna). The container may include a printable surface upon which the printer can directly print or, alternatively, a label upon which the printer can directly print.

Thus, when blood samples are inserted in the carrier unit, the photo-analysis is conducted and the results conveyed to the internal printer, which imprints the blood type directly onto the sample container(s) or their attached labels. Prior to analysis, a patient or donor's identification data may be communicated to the unit via electromagnetic chip, RFID, or barcode reader technology. This identification data may also be printed onto the sample container. The imprinted identification data may also be combined with a Barcode imprint. The sample container(s) may also have an RFID inlet attached to the container so that the donor/blood type data may also be written to the RFID inlet on the container as well as the label.

A process for analyzing one or more bodily fluids includes placing a sample of a bodily fluid, such as a blood sample, in at least one container. The container is placed in a fluid analyzing unit either prior to or after the sample is placed in the container (usually via a blood draw). The sample is then analyzed to determine characteristics of the bodily fluid. The analysis includes reading through the container. The determined characteristics of the sample are then sent to a printer within the fluid analyzing unit that then prints the determined characteristics onto the container itself. The determined characteristics may include at least one of the following: blood type and Rh factor.

Additionally, as part of the process, data may be communicated to the unit (via RFID or a bar code reader); data that identifies a source of the bodily fluid. The data identifying the source of the bodily fluid may also be printed on the container.

The at least one container may be transparent and may further include an RFID inlet. The container may further include a printable surface upon which the printer can directly print or, alternatively, a label upon which the printer can directly, print. The determined characteristics of the sample may be transmitted to the RFID inlet on the container.

The process and system provide better correlation of samples with results and reduce errors by having the blood analysis system directly label the sample containers. Thus, human error factors related to mislabeling/misidentification of the source of blood samples and in the handling of the samples prior to, during, and after analysis may be reduced. The blood analysis system is automatic, relatively compact in size and inexpensive.

Other features and advantages of the invention will become more apparent from the following detailed description, taken in conjunction with the accompanying drawings which illustrate, by way of example, the principles of the invention.

### BRIEF DESCRIPTION OF THE DRAWINGS

The accompanying drawings illustrate the invention. In such drawings:

FIG. 1 is a top plan view of a blood analysis and identification system embodying the present invention;

FIG. 2 is a front elevational view of the blood analysis and identification system of FIG. 1;

FIG. 3 is a schematic view showing the mutual communication between a reader and the carrier unit of the invention; and

FIG. 4 is a schematic view showing the mutual communication between a reader within the carrier unit and the container of the invention

FIG. 5 is a flowchart illustrating a process for analyzing a blood sample, in accordance with the present invention.

### DETAILED DESCRIPTION OF THE PREFERRED EMBODIMENT

The present invention is useful in a variety of applications involving analysis of bodily fluids, such as testing for glucose levels, platelet count, urine analysis, and, in particular, blood type and Rh factor. It provides a means to provide better correlation of samples with results and reduce errors by having the blood analysis and identification system directly label the sample containers. This reduces human error factors related to mislabeling/misidentification of the source of blood samples and in the handling of the samples prior to, during, and after analysis and provides a blood analysis system that is automatic, relatively compact in size and inexpensive. The system can identify blood samples, automatically and without error, to a specific patient. The system is intended to identify and analyze blood from a single person at a time.

A process and system for analyzing a bodily fluid are illustrated and described that reduce human error factors related to the mislabeling or misidentification of blood type. This system is usable in any situation where blood samples are analyzed and labeled for type, including situations where donor blood samples are analyzed and labeled for type, Rh factor, and donor identification. These situations can occur anywhere there is a need to analyze blood, such as hospitals, blood banks, blood-donation organizations, research labs, crime labs, or the like.

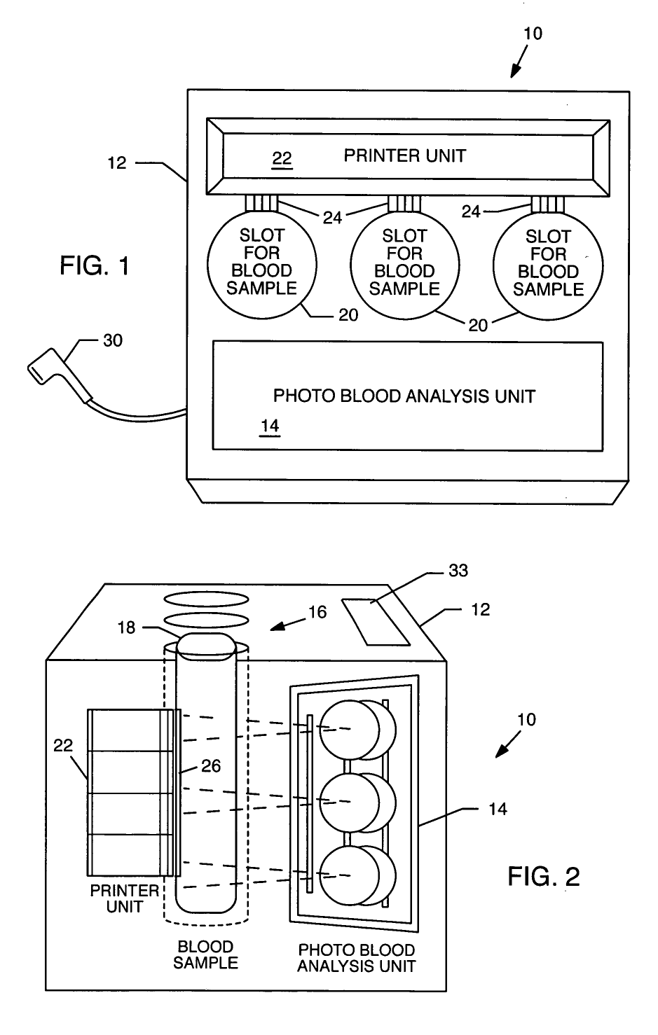

As shown in the drawings for purposes of illustration, the present invention resides in an automatic blood analysis system. With reference to FIGS. 1-5, a blood analysis system 10 includes a single or multi-sample carrier bodily fluid analysis and identification unit (or carrier unit) 12 that encloses a photo (light) blood analysis unit, such as an optical or photo-analyzer 14, that determines characteristics of a sample of a bodily fluid. For example, an analysis of a blood sample can determine various characteristics of the blood, such as blood type and/or Rh factor.

The carrier unit 12 also includes a means 16 for holding at least one sample container 18, in the form of a conventional vacuum container or vacutainer, within the carrier unit 12, such as at least one slot 20 located on a surface of the carrier unit 12 although a plurality of slots 20 are preferred such that multiple samples from the same individual can be identified concurrently. For example, the carrier unit 12 illustrated in FIGS. 1 and 2 includes three slots 20 and each slot 20 is capable of holding a single container 18. The slots 20 of a particular carrier unit 12 may come in a variety of sizes so that the carrier unit 12 is able to accommodate sample containers 18 of various sizes. The number of slots 20 in a particular unit 12 may vary. For example, some units 12 may only have one slot 20 while other units 12 have two, three, four slot 20 and so on.

The carrier unit 12 further includes a printer 22 that is electrically, electronically, and mechanically connected to various components within the carrier unit 12. The printer 22 is located within the carrier unit 12 adjacent to the slot(s) 20. One side of each slot 20 is open to the printer 22 and allows the printer 22 to print the information on the container 18 located within the slot 20. The printer 22 includes at least one printer head 24 such that the printer head 24 prints information on each container 18. Each container 18 may be indexed to the printer head 24 of the printer 22, although each slot 20 may be assigned its own printer head 24 if the printer 22 has multiple printer heads. The printer 22 may be selected from one of several types, including impact printers, ion deposition printers, ink jet printers, laser printers, direct thermal printers, and thermal transfer printers. Identification information may also be printed directly on the containers 18 by laser etching. If direct thermal printing is used, an imaging coating must be provided on any label 26 attached to the container 18. The label 26 may include an adhesive surface that allows the label 26 to be attached to the container 18. The printer 22 may also serve as a label printer and label applicator that prints and applies a label 26 containing patient information onto the container 18.

The sample container 18 may be made of transparent (clear or colored) glass or plastic. Each sample container 18 includes printable surfaces (or surfaces to which printable labels 26 can be attached) along the side(s) of the container 18. The containers may be pre-loaded into the carrier unit 12 prior to the blood sample being drawn. Once the blood sample is drawn into the container(s) 18, and the photo-analysis conducted, the results of the photo-analysis are conveyed to the internal printer 22, which then imprints the determined characteristics and/or identification of the source of the sample directly onto the side of the sample container(s) 18 or their attached labels 26. The sample container(s) 18 may also have an RFID inlet or receiver (i.e., chip & antenna) 28 attached, with the donor/blood type and/or patient identification data also written to the RFID inlet 28 as well as the imprint on the side of the container 18 or on the label 26 attached to the side of the container 18. Alternatively, the blood samples may be drawn into the containers 18 prior to the placement of the containers 18 in the carrier unit 12.

A control unit (not shown) coordinates and controls the functions of each sub-system in the carrier unit 12, such as the printer 22 or photo-analyzer 14. The control unit is located within the carrier unit 12 and is also electrically, mechanically, and electronically connected to each of the sub-systems (photo-analyzer 14, printer 22, etc.) as well as to a display/user interface (not shown) located on the carrier unit 12. The user interface allows a user to program and operate the carrier unit 12. The user interface may come in several forms including, without limitation, a graphical user interface, liquid crystal display, knobs, dials, switches, buttons or the like. The control unit includes a digital computer that has a processor and a memory. A computer program stored within the memory includes at least one program, executed by the processor, which operates the analysis and printing functions when the processor receives electrical signals from the photo-analyzer 14 corresponding to blood type and/or Rh factor, as well as identification information based on a barcode scan or RFID scan. The information may be input manually to the carrier unit 12 as well via the user interface.

At least one software program is stored in the memory to be operated on by the processor within the control unit. This program may include a first sub-routine for operating the photo-analyzer 14 and determining the blood type and/or Rh factor of a blood sample in the carrier unit 12. The program may also include a second sub-routine for printing information, such as blood type and/or Rh factor, on the sample container 18 holding the blood sample. The program may further include a third sub-routine for receiving information transmitted to the carrier unit 12 via RFID or barcode reader technology. A bar code reader or scanner 30 is electrically, electronically, and mechanically connected to the control unit such that the reader 30 is able to scan a barcode associated with a particular patient so that the information can be stored in the control unit. Information relating to that particular barcode may have already been downloaded to the carrier unit 12 so that the control unit is able to correlate the scanned barcode with particular information. The control unit may then associate that particular barcode with a particular sample container 18 located in one of the slots 20 of the carrier unit 12. The control unit may later direct the printer 22 to print that particular barcode on that particular container 18.

The photo-analyzer 14 analyzes a blood sample within the at least one container 18, and electronically sends information regarding the determined characteristics of the blood sample, such as blood type and Rh factor, to the printer 22 via the control unit. The blood sample information is associated with the patient's identification information and stored in the memory of the control unit. The photo-analyzer 14 illustrated in FIG. 2 includes a detector, three scanners, and three scanning beams passing through a container 18 holding a blood sample. The number of scanners and scanning beams may vary depending on the particular photo-analyzer 14 used. Each slot 20 may be assigned a particular set of scanning beams or a single set of scanning beams may be used for every slot 20 in the carrier unit 12.

Prior to photo-analysis of the blood sample, identification data associated with the source of the sample (such as a blood donor) may be communicated to the carrier unit 12 via RFID or the barcode reader technology, as discussed above. Alternatively, other possible methods of communicating identification data to the unit 12 include voiceprint, retinal scan, and fingerprints. All identification data (e.g., patient/donor name, identification number, etc.) and determined characteristics (e.g., blood type, Rh factor, etc.) of the blood sample may be printed onto the sample container 18 by the printer 22. In addition to the imprinted identification data, the printer 22 may also print a Barcode imprint on the container 18.

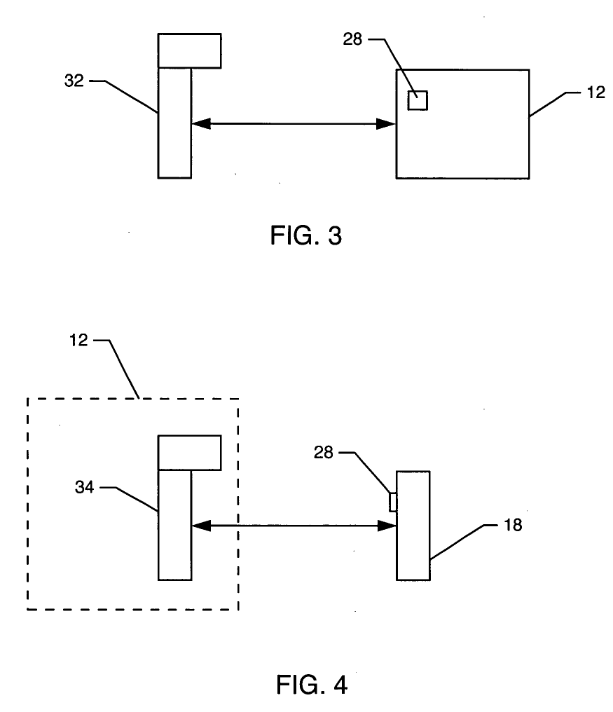

The mutual communication between an RFID reader 32 and the carrier unit 12 is illustrated in FIG. 3 of the drawings. Initially, the RFID circuitry of the reader 32 is programmed to provide identifying and other information and the carrier unit 12 is capable of eliciting such information from the RFID circuitry of the reader 32. The identifying data may include patient name, patient number, etc. The carrier unit 12 may then use the printer 22 to print this identifying data on the container 18 at any time during the process, including printing the patient number on the container 18 in barcode form. In a read/write configuration of the circuitry of the carrier unit 12, the reader may also impart information to, alter information on, or delete information from the carrier unit 12. Likewise, the carrier unit 12 is capable of providing identifying and other information to the RFID circuitry of each container 18, as shown in FIG. 4 which illustrates the mutual communication between an RFID reader 34 in the carrier unit 12 and a container 18. The carrier unit 12 also provides the determined characteristics of the sample within a particular container to the RFID circuitry of that particular container 18.

The carrier unit may also include a user interface 33 which includes a display (such as a liquid crystal display), a thumb print reader, alpha-numeric keypad, and/or various knobs, switches, and controls used to activate/operate the carrier unit 12. The display could employ touchscreen technology that would eliminate the need for physical switches, keypads, or the like.

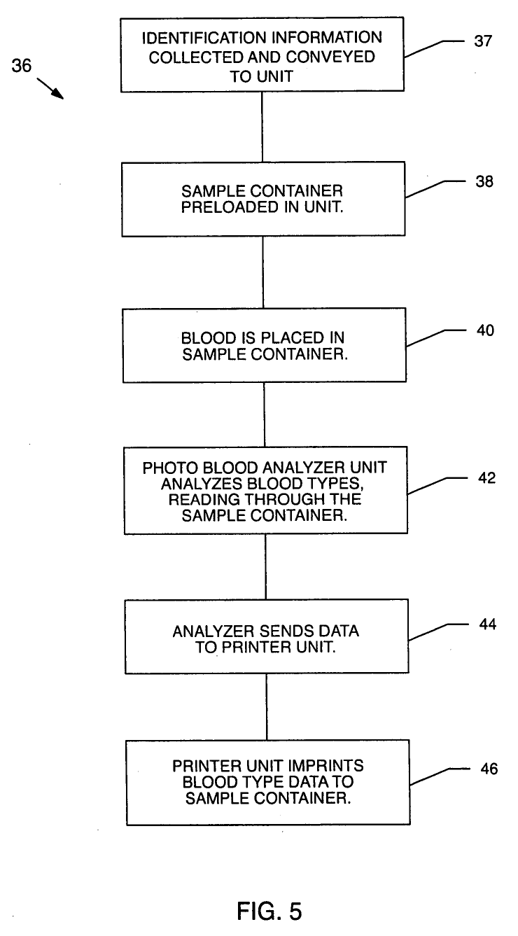

In use, as illustrated in FIG. 5, identification information may be conveyed to the carrier unit 12 before analysis of a bodily fluid begins. Identification information may be conveyed in several ways including, but not limited to, direct input from a technician, a bar code assigned to and/or printed on a wristband attached to the patient that can be read by the unit 12, an RFID transport medium on the patient that can be read by the unit 12, and patient biometric information (including, but not limited to, a retinal scan, fingerprint scan, and voice print).

The process of entering identification information which can be printed on the container(s) 18 can begin at a hospital check-in desk or admittance station. At the hospital admittance station, patient enrollment or return patient verification occurs (i.e., the patient arrives at the hospital check-in center and provides pertinent information). The patient may be asked to do a number of things to verify identification. The patient may be asked to place his or her finger or thumb on a patient identification pad in the form of a fingerprint reader in order to obtain a digitized fingerprint. Digitized fingerprint information may then be written to an RFID wristband that is printed out for the patient on the spot. The patient will wear the RFID wristband during their hospital stay. The RFID wristband contains relevant hospital information along with the patient's personal identification information (e.g., their digitized finger print information). With the RFID wristband on the patient's wrist, there is decreased risk of a patient switching wristbands with another patient and/or being misidentified. The digitized finger print on the RFID wristband must always match the actual finger print on the patient's hand.

The fingerprint information may be stored on the RFID chip of the wristband in the following manner. A fingerprint reader registers a patient's thumb or fingerprint. Electronics within the fingerprint reader reads the peaks and valleys of the fingerprint. The electronics identify the unique minutia and store the data as a file with the file size depending on the level of security desired. This information may then be then written to the RFID chip of the patient's wristband. Actual fingerprint data is discarded and the fingerprint cannot be recreated by the minutia data, hence there are no privacy issues.

After check-in, the patient can then be sent to his or her hospital room. In the room, identification verification may take place when blood or other bodily fluid is drawn. In the hospital room, blood or other bodily fluid may be drawn by a nurse and/or other medical practitioner. The blood may be drawn directly into the container(s) 18 already pre-loaded into the carrier unit 12 or the blood may alternatively be drawn into a container 18 that is then placed in a slot 20 of the carrier unit 12. Identification information may be downloaded or written to the carrier unit 12 prior to blood or any other bodily fluid being drawn using various technologies including, but not limited to, bar code and RFID technology. The carrier unit 12 is a stand alone unit that does not need to be networked or connected to the hospital IS system or any other system whereby information may be conveyed to the unit 12. The identification information imprinted on the wristband RFID chip provides the information that is downloaded to the carrier unit 12. All additional information that is eventually written to the RFID chip on the container 18 is determined by the carrier unit 12 during the analysis process. Alternatively, the identification information may be written to the unit 12 at the same time the information is written to the patient's RFID wristband at check-in if the unit 12 is networked to the hospital IS system. If the unit 12 is networked to the hospital IS system, the unit 12 receives constant updates of information. The unit 12 may be activated-by confirmation of the patient's identification information. Such confirmation may occur via thumb print verification (i.e., a fingerprint reader built into the unit 12 that reads the patient's thumb print when placed on the reader), password verification (i.e., entering a password into the user interface of the unit 12), or RFID verification when data stored within the carrier unit 12 is matched with that stored on the RFID wristband worn by the patient either because the information on the RFID wristband was previously downloaded to the unit 12 or the unit 12 is connected to the hospital IS system. The unit 12 may also be programmed to activate upon being downloaded with new identification information. The unit 12 may also be manually activated. Another method of identification includes using the bar code scanner 30 to bar code scan the bar code that may be present on the patient's wristband and then matching the bar code on the patient's wristband to information stored within the carrier unit 12. Whichever method is used, if the identification information does not match, the blood analysis carrier unit 12 will not activate. In the event that blood is to be drawn directly into a container 18 already within the carrier unit 12, the carrier unit 12 will not allow blood to be drawn if the identification information does not match. In that event, the carrier unit 12 will also not allow information to be printed onto the vacuum container or written to the vacuum container 18 if RFID technology is being used.

The container 18 may be pre-loaded or placed in the slot 20 while still empty 38 and then directly filled with a bodily fluid while in the slot 20. The process for analyzing one or more bodily fluids 40 begins once a sample of a bodily fluid to be analyzed, such as blood, is placed in at least one container 18, pre-loaded. The container 18, depending on its size, will be placed in a slot 20 large enough to accommodate its size.

Data which identifies a source of the blood may be communicated to the carrier unit 12 prior to analyzing the blood sample. Data identifying the source of the blood sample may be communicated to the carrier unit 12 via RFID or bar code reader technology, as outlined above. This identifying data may then be printed on the container 18, prior to, during or after the analysis.

The blood sample is then analyzed 42 to determine characteristics of that particular bodily fluid. The photo analyzer 14, reading through the material of the container 18, analyzes the sample to determine the characteristics of the blood sample. As stated above, these determined characteristics may include blood type, Rh factor, etc. If several blood samples are in different containers 18 in the unit 12, once one of the samples is analyzed for type and Rh factor, the other samples need not be analyzed as they will presumably be identified since they come from the same individual. The photo-analyzer 14 then sends 44 data regarding the determined characteristics to the printer 22 which then prints 46 the information and determined characteristics onto the surface of the container 18. The printer 22 may print information on a printable surface of the container 18, or a label 26 placed on the container 18, using alpha-numeric lettering and/or bar code form. If the container 18 includes an RFID inlet 28, the data may also be ‘written’ or transmitted to the RFID inlet 28 on the container 18. Data identifying the source of the blood may also be transmitted to the container 18 via RFID technology. Any commercially available RFID chip may be used, including, for example, Hitachi Corporation's mu-chip which is wireless accessible at 2.4-2.45 GHz, can store up to 128 bits of data, and at 0.4 mm square is thin enough to be embedded in a label attached to the sample container or within a part of the container itself. An antenna for receiving incoming data is connected to the RFID chip.

It is well known to those skilled in the art that RFID circuitry of the type under discussion is provided in a plurality of configurations; for example, read only, read/write, passive, and active. The read only provides previously installed information from the RFID circuit through a compatible reader. The read/write circuit permits the reader to install or alter information stored in the circuit. The passive circuit is one which depends for activation and operating power upon the signal emitted by the reader while the active circuit includes a battery or other internal power source which may be activated by the signal from the reader.

The carrier unit 12 may be powered by an outside source (e.g., a power cord connects the unit 12 to a wall socket or the like) or by a battery located within the unit 12 that is electrically connected to sub-systems, such as the photo-analyzer 14 and/or the printer 22. The battery may be a rechargeable battery that is rechargeable while still within the unit 12 by connecting the unit 12 to an outside power source.

Alternatively, the unit 12 may be connected to a personal computer, central server, handheld device, etc. either by cables, RFID or wireless technology.

In the alternative, the patient's identification information may be downloaded and/or written to a hospital central server at the time the patient is checking in at the hospital admittance station. The hospital central server may contain a data base of all fingerprints and identification information of every patient admitted to the hospital where that patient's identification information has been entered into the hospital server. This hospital central server could be linked with other hospitals, city or nationwide, to share identification data with other medical facilities in order to prevent fraud, identity theft, drug abuse, etc. In this situation, the fingerprint data file stored on a patient's RFID wristband is also stored in the hospital's central server so that the information may be referred to at a later time. This provides the benefit of an additional layer of security to the hospital. For example, county hospitals may face a security issue where unscrupulous people utilize the hospital as a source of drugs for their benefit. These people may provide different identification during different visits in order to be able to obtain drugs for whatever ailment they may be currently feigning. This can cost hospitals vast sums of money as there is no method of cross-checking the various identities these people may provide at check-in. Software within the check-in computer used at the hospital admittance desk would allow the check-in computer to communicate with the hospital's central server. This software would allow the fingerprint minutia data to be sent to the hospital server so that the data could be compared to all the other people who have been entered into the system. For example, a person may come into the hospital and provides his/her identification information. The patient has a fingerprint read and stored in the hospital system. The patient is then treated for his ailment. If, for example, a few days later, the same person arrives at the hospital again, the system will be able to check for a disparity between the identification submitted in the past and present since both sets of identification will be associated with the same fingerprints. When the patient goes to the check-in station and provides the identification, the check-in computer will send that new data to the server. If the identification sent to the server matches information already stored on the server, a patient wristband will be provided to that person checking in. However, if the identification the person provides does not match the identification already associated with the fingerprint stored on the server, the hospital will act accordingly. In the alternative, an additional layer of security could be added by including a photo identification of a patient. This photo could be taken by a digital camera and the information then stored within the hospital central server. The photo could also be printed on the patient's RFID wristband. This would provide an additional layer of security, as well as display the patient's photo on the wristband for additional visual identification. This would further facilitate identification at the check-in station as the stored photo could be visually compared to the person whose fingerprint is currently being read. This would also allow the digital photo to be displayed on the display built into the user interface 33 of the carrier unit 12. The display on the carrier unit 12 would allow the patient's identification information to be displayed as well as the patient's digital photo. This would provide a further visual identification and therefore additional security.

In another alternative, networking capabilities could be added to the carrier unit 12 that would allow it to use an always-on wireless method in order to enable the carrier unit 12 to be in constant communication with the hospital's central server.

While the system 10 of the present invention has been described in a hospital or medical setting, applications are possible in other settings. For example, the present invention is also applicable in business settings, law enforcement settings, field paramedical settings, or home settings where identification of the characteristics of a bodily fluid is combined with the need to match the sample with its source and to identify the source and/or the characteristics of the sample on the sample container.

The above-described embodiments of the present invention are illustrative only and not limiting. It will thus be apparent to those skilled in the art that various changes and modifications may be made without departing from this invention in its broader aspects. Therefore, the appended claims encompass all such changes and modifications as falling within the true spirit and scope of this invention.

1. A process for analyzing one or more bodily fluids, comprising the steps of:
placing a sample of a bodily fluid in at least one container;
placing the container in a fluid analyzing unit;
analyzing the sample to determine characteristics of the bodily fluid;
sending the determined characteristics to a printer within the fluid analyzing unit; and
printing the determined characteristics onto the container.

2. The process of claim 1, further comprising the steps of communicating data to the unit which identifies a source of the bodily fluid, and printing the data identifying the source of the bodily fluid on the container.

3. The process of claim 2, including the step of communicating the data identifying the source of the bodily fluid to the unit via radio frequency identification (RFID).

4. The process of claim 2, including the step of communicating the data identifying the source of the bodily fluid to the unit via a bar code reader.

5. The process of claim 1, wherein the analyzing step includes the step of reading through the container.

6. The process of claim 1, wherein the at least one container includes a radio frequency identification (RFID) inlet.

7. The process of claim 6, including the step of transmitting the determined characteristics to the RFID inlet on the container.

8. The process of claim 1, wherein the sample is a blood sample.

9. The process of claim 1, wherein the determined characteristics include at least one of the following: blood type and Rh factor.

10. The process of claim 1, wherein the at least one container is transparent.

11. A process for analyzing one or more bodily fluids, comprising the steps of:
placing a sample of a bodily fluid in at least one transparent container;
placing the container in a fluid analyzing unit;
writing data identifying a source of the bodily fluid to the fluid analyzing unit;
analyzing the sample to determine characteristics of the bodily fluid;
sending the determined characteristics to a printer within the fluid analyzing unit; and
printing both the data identifying the source of the bodily fluid and the determined characteristics onto the container.

12. The process of claim 11, wherein the at least one container includes a radio frequency identification (RFID) inlet;

13. The process of claim 12, including the step of transmitting the determined characteristics to the RFID inlet on the container.

14. The process of claim 11, wherein the writing step includes the step of writing the data identifying the source of the bodily fluid to the unit via radio frequency identification (RFID).

15. The process of claim 11, wherein the writing step includes the step of communicating the data identifying the source of the bodily fluid to the unit via a bar code reader.

16. The process of claim 11, wherein the analyzing step includes the step of reading through the container.

17. The process of claim 11, wherein the sample is a blood sample, and wherein the determined characteristics include at least one of the following: blood type and Rh factor.

18. An automatic blood analysis and identification system, comprising:
a carrier unit;
means for holding at least one container within the unit;
a printer disposed within the unit and capable of printing information onto the at least one container; and
a photo-analyzer for analyzing a blood sample within the at least one container, and sending information to the printer for printing the information on the at least one container.

19. The system of claim 18, wherein the at least one container includes a radio frequency identification (RFID) inlet.

20. The system of claim 18, wherein the printer prints directly onto a surface of the at least one container.

21. The system of claim 18, wherein the at least one container includes a label such that the printer prints directly onto a surface of the label.

22. The system of claim 21, wherein the at least one container is transparent.

23. The system of claim 18 wherein there are at least three slots within the unit, wherein each slot is configured to hold a container.

24. The system of claim 23, wherein the printer includes at least one printer head assigned to each slot.

25. An automatic blood analysis and identification system, comprising:
a carrier unit;
at least three slots within the unit, wherein each slot is configured to hold a transparent container having a radio frequency identification (RFID) inlet;
a printer disposed within the unit and capable of printing information onto each container within the unit; and;
a photo-analyzer for analyzing a blood sample within at least one container, determining information including blood type and Rh factor from the blood sample, and sending the information to the printer for printing the information on the at least one container.

26. The system of claim 25, wherein the printer prints directly onto a surface of the at least one container.

27. The system of claim 25, wherein the at least one container includes a label such that the printer prints directly onto a surface of the label.
